(19) United States
(12) Patent Application Publication
(10) Pub. No.: US 2010/0178856 A1
(43) Pub. Date: Jul. 15, 2010

(54) Cordless power gasket scraper and surface cleaning tool with light source

(76) Inventor: Omar Jesus Cruz, Tampa, FL (US)

Correspondence Address: Omar J. Cruz, 6416 Willow Wood Ct,, Tampa, FL, 33634, US

(21) Appl. No.: 12/319,580

(22) Filed: Jan. 9, 2009

(51) Int. Cl. B24B 23/04; H02J 7/00

(52) U.S. Cl. 451/356; 320/114; 362/119

(57) ABSTRACT

A power gasket scraper with cordless capability (12) for ease of maneuverability, work in confined spaces, and reduced time for completion of surface preparation. LED light (1) to illuminate work area, interchangeable attachments (FIGS. 2, 3, 4, 5, 6) for different surfaces to be removed or cleaned, spring release (2) with 15° roll on spring blade clamp for attachments, stationary or interchangeable rechargeable battery (11) with button release (16). A variable speed option (4,5) gives the user the ability to control different intensities of oscillation with minimal physical exertion, while a locking trigger switch (18) can maintain a constant speed when desired. A non-slip rubber coating is applied for stability and safety (15).

### CROSS-REFERANCE TO RELATED APPLICATIONS

This application claims the benefit of provisional patent application Ser. No. 61/007,054, filed Dec. 11, 2007 by the present inventor.

### FEDERALLY SPONSORED RESEARCH

Not Applicable

### SEQUENCE LISTING OR PROGRAM

Not Applicable

### BACKGROUND

1. Field of Invention

This invention generally relates to gasket material removal and surface cleaning tools, specifically tools for individual use on pumps, engines, and various aspects of machinery.

2. Prior Art

Presently, pneumatic tools and power tools are available for gasket scraping and surface preparation, however these tools are cumbersome and lack maneuverability, and require additional equipment to be used, such as air hoses, compressors, generators, power cords. Currently, these tools have no attached mechanism for lighting up small spaces or ill-lit work areas, and typically each tool only serves one purpose, requiring multiple tools for a single project. Also, these tools do not have variable speed options, are ill-suited to portability, and must be attached to a power source in order to be used.

### SUMMARY

A cordless power scraper, with affixed lighting, variable speed options, and attachments included for ease of use, portability, and removal of material from various surfaces.

### DRAWINGS—FIGURES

In the drawings, closely related figures have the same number but different alphabetic suffixes.

FIGS. 1A and 1B show an outer and inner view of a power gasket scraper with light source in accordance with one embodiment.

FIG. 2 shows a wide attachment used for scraping 45° corners in this embodiment.

FIG. 3 shows a medium attachment used in conjunction with round scouring pad in this embodiment.

FIG. 5 shows a scouring pad face with securing threads to be used in conjunction with the attachment shown if FIG. 3 in this embodiment.

FIG. 6 shows a steel-bristle brush used for surface cleaning in this embodiment.

### LIST OF REFERENCE NUMERALS

1. LED light
2. Spring blade clamp release
3. Internal wires to battery, switches, motor, and light.
4. Exterior variable lever, on/off/speed selector switch.
5. Interior variable speed slide on/off/selector electric switch.
6. Spring for exterior slide switch.
7. Actuator mechanism for oscillation of attachments (see FIG. 18-22)
8. Electric motor.
9. Wire connections to motor.
10. Battery connections to electric motor.
11. Internal or interchangeable battery.
12. Charging socket.
13. Shell-securing screw holes.
14. Activator coupler.
15. Exterior rubber skin.
16. Changeable battery release.
17. Electric motor air supply vents
18. Trigger on/off switch

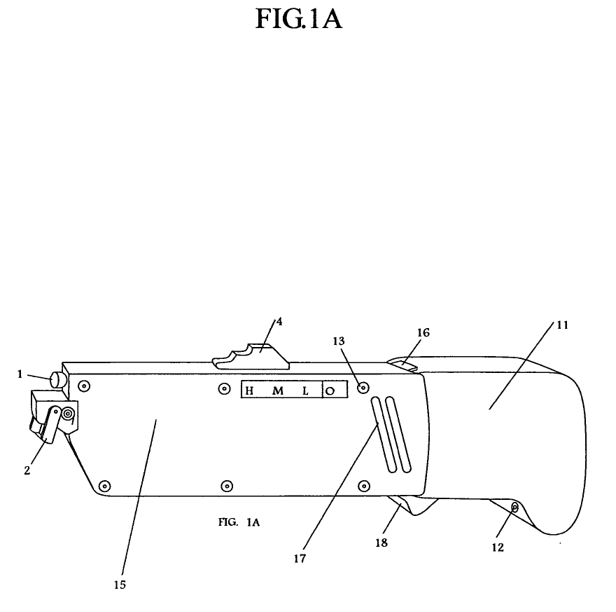

### DETAILED DESCRIPTION—FIG. 1A TO FIG.7—PREFERRED EMBODIMENT

One embodiment of the gasket scraper is illustrated in FIG. 1A (outer view) and FIG. 1B (inside view). 1-15 illustrate details of the gasket scraper and its components, including an LED light (1), cordless power capability (10-12), and interchangeable attachment spring blade clamp release (2).

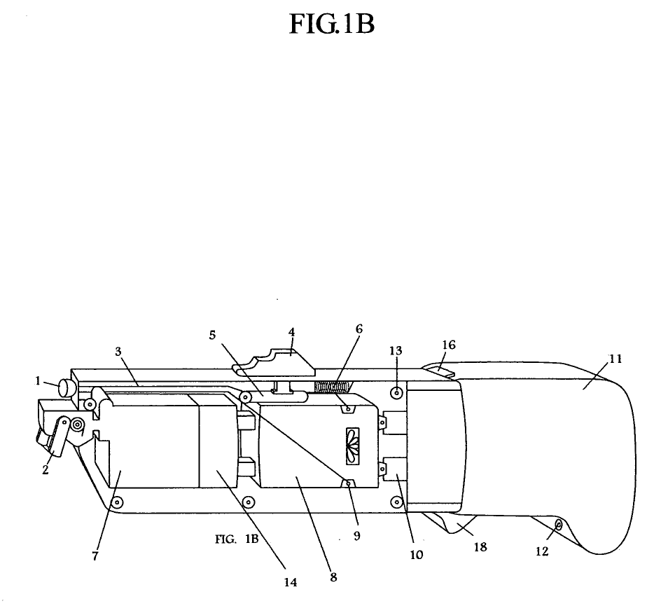

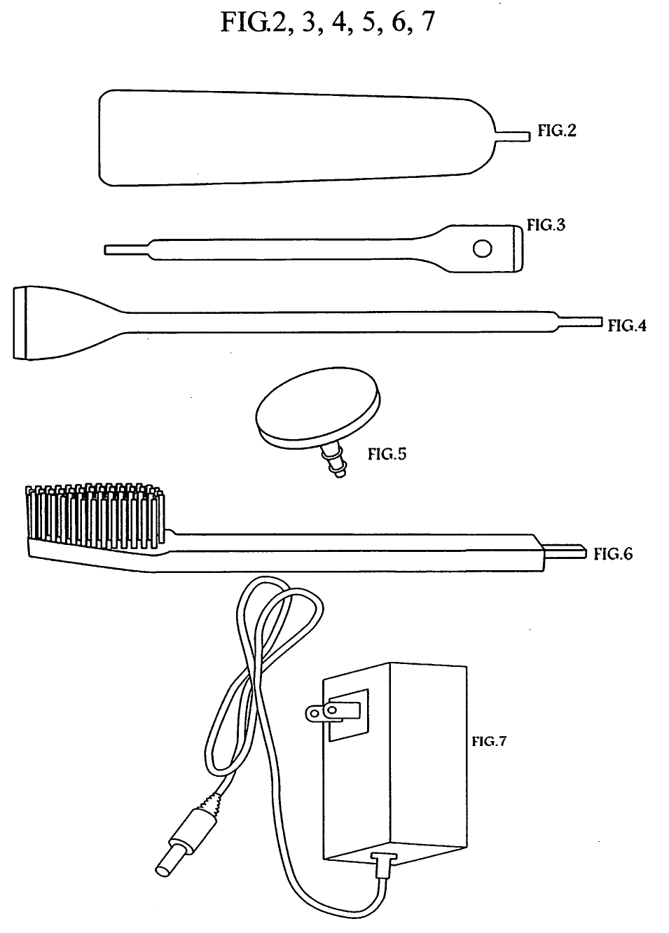

The gasket scraper includes a LED light source (1), with internal wiring connecting LED to motor (3, 9) and on/off/speed selector switch (4,5) and on/off trigger switch (18). The cordless function of the gasket scraper is facilitated by the removable rechargeable battery (11), charging socket (12), battery connections to electric motor (10), and A/C adapter (FIG. 7). The electric motor (8) is attached to the coupler (14), actuator (7) and spring blade clamp release (2). The clamp release, (2) has a 15° roll, and no more than ¼″ of oscillation in any direction. This serves as the housing for multiple attachments (FIGS. 2-6) that can be used for a variety of functions, and a rapid release for exchange.

The exterior slide on/off switch (4) is facilitated by the spring (6) for the exterior switch.

The plastic housing of the gasket scraper is encased in a rubber skin (15), and is held secure by six securing screw holes (13). Air is supplied to the electric motor via a ventilation system (17) on the outer shell of the gasket scraper.

Operation—FIGS. 1A-7

Using a traditional gasket scraper, one would first decide whether to use a manual or pneumatic option. If going the manual route, it is very labor intensive work, which is cumbersome on the body and normally results in abrasions on the knuckles and hands. Due to the repetitive motion of manual scraping, it is tedious and time consuming. Pneumatic gasket scrapers are a faster option, but they are difficult to maneuver and require additional equipment to be used efficiently.

In the preferred embodiment of this invention, its cordless capability, via the battery connections to the electric motor (10), the internal or interchangeable battery (11), and charging socket (12) with A/C adapter (FIG. 7), makes it much less cumbersome on the body, while still maintaining efficiency and improving upon the safety of the user. In that it is a power tool, as opposed to a hand tool, the repetitive motion of the hands is avoided, and injury is much less likely. The exterior rubber skin (15) minimizes hand slippage, and the LED light (1) also provides a measure of safety in that it lights the workspace and work surface, providing the ability to avoid hazards otherwise unseen.

The optional attachments (FIGS. 2-6) reduce exertion and fatigue from movement, such as climbing down ladders for additional tools, repositioning the body, or otherwise being forced to leave the work space. They are continually at hand, and simply require the pressing of a lever (2) to switch the surface preparation tool as needed for the particular surface being worked on. The 15° roll on the spring blade clamp (2) and actuator (7) assists in the stability and control of the tool, as slight movements of the hand or wrist would not disrupt the balance or efficiency in use of the tool. Usually, extraneous movements of the hand would cause gouging, scarring, scratching, and/or damage to the scraper edge.

The variable speed, exterior slide on/off switch (4), facilitated by a spring mechanism (6), allows for user-friendly positioning and ability to adapt speed for the surface being worked. For example, a harder surface would require a high speed, while a softer surface would require a slower speed. In that this tool is capable of multiple speeds, the user would not have to exert themselves to the point of injury, nor would the surface be ruined by currently available power and/or hand tools that do not adjust to the surface being worked. For occasions where one constant speed is desired, the locking on/off trigger switch (18) may be used.

The wires (3) to the motor (8), the motor's brass connectors (9), interior switch (5), and LED light (1) are encased inside of the shell, which is coated in rubber (15) to aid in stability, and secured with shell-securing screws (13). The tool maintains its temperature via air vents (17) on the shell housing, which also has a port (12) for the 6.2-7.3 volt electric battery charger. The activator coupler, which holds the motor and actuator together, is also encased in the shell. The changeable battery release (16), located on the back end of the tool, facilitates the charging of one battery and use of another.

In another embodiment, the tool may not have a battery release, but an internal stationary battery that is rechargeable.

### CONCLUSION, RAMIFICATIONS, AND SCOPE

Accordingly, the reader will see that the cordless power gasket scraper with light source and its embodiments can be used in preparation of surfaces and the preservation of the integrity of the surface to be worked. The embodiments can be useful in the fields of marine, auto, aviation and any other engineering fields for the processes of rebuilding machinery, engines, pumps and other surfaces. The embodiments can also be used in the home and also in the field of construction. The embodiment can be used on any surface that needs cleaning, resurfacing, or other forms of preparatory work to leave a clean surface for whatever finish is desired.

While my above description contains many specificities, these should not be construed as limitations on the scope of the invention, but rather as an exemplification of preferred embodiment thereof. Many other variations are possible. For example, it could be made larger or smaller, for different surfaces. It could be made into an industrial machine to be used on a larger scale. The rubber coating could be given a different texture pattern. A stronger motor could be used in an industrial embodiment for the scraping of the bottom of dry docked boats and the like. A constant power source, such as an A/C adapter with 20 foot cord, could be applied. Saw blade attachments could be used in the place of resurfacing attachments, thus creating a cordless power saw.

Accordingly, the scope of the invention should be determined not by the embodiment(s) illustrated, but by the appended claims and the legal equivalents.

I claim:

1. A hand-guided power tool, comprising:
a. a surface-material removal tool having variable attachments mounted on said tool via spring blade clamp release with roll to facilitate oscillation
b. a light mounted in said tool for illumination of workspace
c. a cordless power function with rechargeable battery, battery release, and charging socket
d. a rubber grip coating on said tool to aid in handling
e. a variable-speed or locking-trigger control for varying intensity of oscillation
